(19) United States
(12) Patent Application Publication
(10) Pub. No.: US 2008/0272925 A1
(43) Pub. Date: Nov. 6, 2008

(54) Safety-Enhanced Electrical Circuit Interrupter

(76) Inventors: L. David Griffin, Highland, UT (US); J. La Var Oldham, Sandy, UT (US)

Correspondence Address: PATE PIERCE & BAIRD, 175 SOUTH MAIN STREET, SUITE 1250, SALT LAKE CITY, UT, 84111, US

(21) Appl. No.: 11/743,817

(22) Filed: May 3, 2007

(51) Int. Cl. G08B 21/00

(52) U.S. Cl. 340/638

(57) ABSTRACT

A circuit interrupting device is disclosed in one embodiment in accordance with the invention as including an input line to conduct electrical current from a source of electricity, a first output line to conduct electrical current to a load, and a second output line to conduct electrical current to a receptacle. A movable bridge is provided to electrically connect and disconnect the input line, first output line, and second output line, to and from one another. A circuit interrupting mechanism is provided to disconnect the input line, first output line, and second output line from one another by moving the bridge into an open position upon detection of a predetermined condition. Similarly, a reset mechanism is provided to electrically connect the input line, first output line, and second output line to one another by moving the bridge into a closed position.

### BACKGROUND

1. The Field of the Invention

This invention relates to electrical devices and more particularly to devices for interrupting electrical circuits in response to predetermined conditions.

2. The Background of the Invention

Electrical distribution systems have made electrical power available to nearly all of civilized society. Electricity powers devices for work, entertainment, and healthcare, and is present in nearly every aspect of modern day-to-day living. Typically, electricity is delivered to homes and businesses at voltage and current levels that can seriously and potentially fatally injure individuals coming into direct contact with the electricity.

Various safety devices have been developed to protect individuals from certain situations where they may come into contact with electricity. Some of these devices interrupt power supplied to conductors if a situation is sensed, indicating a fault such as grounding. For example, such a condition may exist when an individual has electrical current flowing from an appliance through him or her. Especially dangerous are wet areas such as bathrooms, kitchens, garages, and outdoor locations. In these areas, current may more easily pass through an individual directly to ground.

To provide protection in these areas, ground fault circuit interrupters (GFCIs) are able to detect differences in current between phase and neutral conductors. When the current of the phase and neutral conductors is not balanced, this may indicate that current is flowing to ground through an alternate path, such as through an individual in contact with the phase conductor. Because even small amounts of current may be fatal, GFCIs may be designed to detect current in the range of 10 mA. When a current leak is detected, the GFCI will trip, resulting in the disconnection of the line electricity source from receptacle or load terminals.

Typical GFCIs have a hardwired electrical connection between receptacle terminals and load terminals used to supply power to outlets downstream from a GFCI in order to make these outlets ground fault protected as well. This direct connection can result in a dangerous situation when the line and load terminals are incorrectly wired. For example, if a source of electricity is mistakenly connected to the load terminals instead of the line terminals, ground faults may go undetected in many cases. Furthermore, the receptacles will never be disconnected from the source of electricity because of their hard-wired connection to the load terminals.

The subject matter claimed herein is not limited to solving the problems described above, nor is the subject matter limited to operation in environments such as those described above. Rather, the above background is provided only to illustrate one exemplary technology area where some embodiments in accordance with the invention and described herein may be practiced.

### BRIEF SUMMARY

Consistent with the foregoing, and in accordance with the invention as embodied and broadly described herein, a circuit interrupting device is disclosed in one embodiment in accordance with the invention as including an input line to conduct electrical current from a source of electricity, a first output line to conduct electrical current to a load, and a second output line to conduct electrical current to a receptacle.

A movable bridge is provided to electrically connect and disconnect the input line, first output line, and second output line, to and from one another. A circuit interrupting mechanism is provided to disconnect the input line, first output line, and second output line from one another by moving the bridge into an open position upon detection of a predetermined condition. Similarly, a reset mechanism is provided to electrically connect the input line, first output line, and second output line to one another by moving the bridge into a closed position.

In certain embodiments, the movable bridge may rotate between the open and closed positions. In other embodiments, the movable bridge may move substantially linearly between the open and closed positions.

In another embodiment, a circuit interrupting device in accordance with the invention includes an input line to conduct electrical current from a source of electricity and multiple output lines to conduct electrical current to one or more loads. A movable bridge is provided to electrically connect and disconnect the input line and each of the electrical output lines to and from one another.

A circuit interrupting mechanism is provided to disconnect the input line and each of the electrical output lines from one another by moving the bridge into an open position upon detection of a predetermined condition. A reset mechanism is provided to electrically connect the input line and each of the electrical output lines to one another by moving the bridge into a closed position.

In another embodiment, a circuit interrupting device in accordance with the invention includes an input line to conduct electrical current from a source of electricity, a first output line to conduct electrical current to a load, and a second output line to conduct electrical current to a receptacle. A bridge is provided to electrically connect and disconnect the input line, the first output line, and the second output line to and from one another.

A circuit interrupting mechanism is provided to disconnect the input line, the first output line, and the second output line from one another by moving once or more of the input line, the first output line, the second output line, and the bridge into an open position upon detection of a predetermined condition. Similarly, a reset mechanism is provided to electrically connect the input line, the first output line, and the second output line to one another by moving one or more of the input line, the first output line, the second output line, and the bridge into a closed position.

This Summary is provided to introduce selected concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be clear from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a high-level, schematic drawing of one embodiment of a circuit interrupting device in accordance with the invention;

FIG. 2 is a high-level, mechanical, schematic drawing of a circuit interrupting device in accordance with the invention; and

FIG. 3 is a schematic drawing that illustrates one alternative embodiment of a bridge operating by rotational movement.

### DETAILED DESCRIPTION

It will be readily understood that the components of the present invention, as generally described and illustrated in the Figures herein, could be arranged and designed in a wide variety of different configurations. Thus, the following more detailed description of the embodiments of apparatus and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

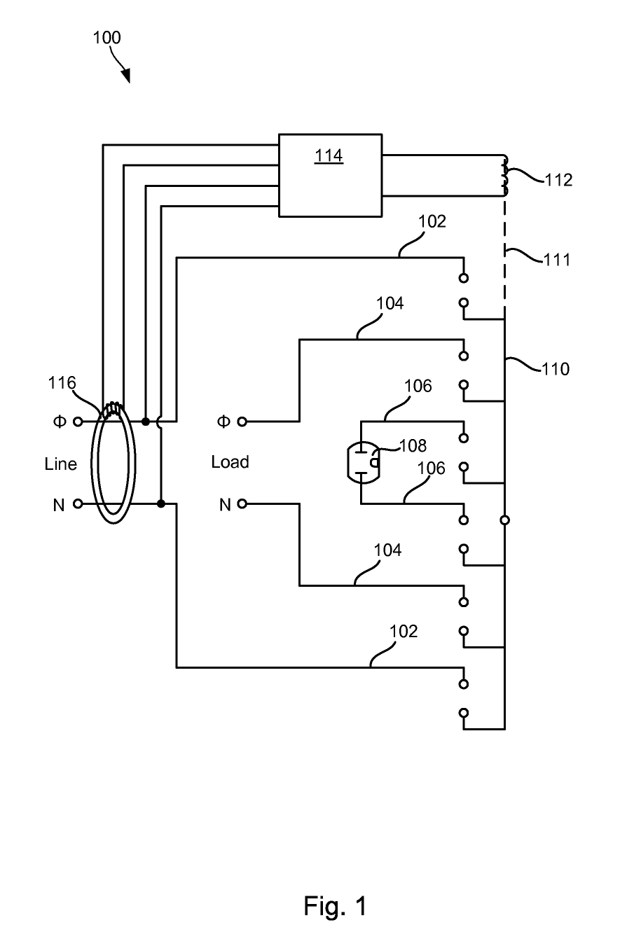

Referring now to FIG. 1, a schematic representation of one embodiment of a GFCI 100, or circuit interrupting device 100, is illustrated. FIG. 1 illustrates input lines 102, load output lines 104, and receptacle output lines 106. The input lines 102 are configured to electrically connect to a source of electricity. For example, the input lines may include any of a number of crimps, wire terminals, clamps, contacts, or the like to connect to conductors, such as wires, bus bars, or the like, carrying electrical current.

The load output lines 104 are configured to electrically connect to a load for supplying electricity thereto. For example, the load output lines 104 may include crimps, wire terminals, clamps, contacts, or the like to connect the output lines 104 to an electrical load. In selected embodiments, it may be desirable to provide ground fault protection to electrical receptacle outlets located downstream from a GFCI 100. A GFCI 100 may also include receptacle output lines 106. The receptacle output lines 106 may connect to a receptacle 108, such as those receiving an electrical plug.

FIG. 1 further illustrates that the input lines 102, the load output lines 104, and the receptacle output lines 106 are not hard-wired together. This configuration prevents electrical current from flowing between the input lines 102, the load output lines 104, and the receptacle output lines 106 when the GFCI 100 is wired correctly (i.e., with the electricity source connected to the input lines 102) and the GFCI 100 has been tripped (i.e., circuit opened). Further, this prevents electrical current from flowing between the input lines 102, the load output lines, and receptacle output lines 104 when the GFCI 100 is wired incorrectly (i.e., with the electricity source connected to the load output lines 104 instead of the input lines 102) and the GFCI 100 has been tripped.

A GFCI 100 in accordance with the invention may also include a movable bridge 110. As illustrated, the movable bridge 110 is a separate component from the input lines 102, the load output lines 104, and the receptacle output lines 106. By moving the bridge 110, the bridge 110 is configured to electrically connect the input lines 102, the load output lines 104, and the receptacle output lines 106 together.

Notably, as shown in FIG. 1, the movable bridge 110 is configured to electrically connect the phase conductors together separately from the neutral electrical conductors. Those of skill in the art will recognize that this prevents a short circuit from occurring. Thus, electrically connecting the input lines 102, the load output lines 104, and the receptacle output lines 106 may involve connecting the phase and neutral conductors together separately.

A number of different circuit interrupting mechanisms may be used to move the bridge 110 to electrically connect the input lines 102, the load output lines 104, and receptacle output lines 106 together. For example, in one embodiment the movable bridge 110 may be connected to a mechanical plunger which may be actuated by a user. In other embodiments, an electrical solenoid 112 may be used to mechanically move the bridge 110. In this example, the dotted line 111 represents a mechanical, as opposed to an electrical, connection 111.

Other mechanisms, although not specifically enumerated here may also be used to move the bridge 110 to electrically connect or disconnect the input lines 102, the load output lines 104, and the receptacle output lines 106. These and other mechanisms may also be used as a reset mechanism to reset the GFCI 100 when the GFCI 100 has been tripped, as will be explained in more detail below.

While the example illustrated in FIG. 1 shows a movable bridge 110 to connect and disconnect the input lines 102, load output lines 104 and receptacle output lines 106, other embodiments may be implemented using a static bridge 110. In such embodiments, one or more of the input lines 102, load output lines 104, and receptacle output lines 106 may be moved relative to the bridge 110 to have the same effect as a movable bridge 110. In other embodiments, the GFCI 100 may include a movable bridge 110 as well as movable input lines 102, load output lines 104, and receptacle output lines 106, or combinations thereof, to provide a similar result.

Various mechanisms may be used to hold a movable bridge 110 in contact with the input lines 102, load output lines 104, and receptacle output lines 106. For example, a solenoid 112 may be bistable to hold the movable bridge 110 in two each of two distinct positions (e.g., open and closed). Alternatively, latches, mechanical barriers, springs, levers, or similar devices may be used to mechanically hold the movable bridge 110 in a position electrically connecting the input lines 102, load output lines 104, and receptacle output lines 106 together, or conversely, disconnect them. In other embodiments, a solenoid 112 may be used to hold the movable bridge 110 in position using electromechanical force to connect the input lines 102, load output lines 104, and receptacle output lines 106 together.

A GFCI 100 in accordance with the invention may also include sensing and control circuitry 114 as part of its circuit-interrupting mechanism. In one embodiment, the sensing and control circuitry 114 may be connected to a current sensor 116. In this example, the current sensor 116 is embodied as a current transformer. As shown in this example, the phase and neutral conductors of the input lines 102 may be routed through a toroidal body of the current sensor 116.

As long as the currents in the phase and neutral conductors are balanced, i.e., the current in the phase conductor is opposite in magnitude and phase to the current in the neutral conductor, no substantial current will flow through the current sensor 116. However, if the current in the phase and neutral conductors becomes unbalanced, i.e., the magnitude of current in one of the conductors has an absolute magnitude less than the absolute magnitude of the current in the other conductor, a net non-zero flux will create a current flowing through the windings of the current sensor 116. This current may be detected by the sensing and control circuitry 114.

If the current detected by the sensing and control circuitry 114 is of sufficient magnitude to meet a selected threshold, the sensing and control circuitry 114 may be designed to trip the GFCI 100 by actuating the bridge 110 with the solenoid 112. This disconnects the input lines 102, load output lines 104, and receptacle output lines 106 from each other. The solenoid 112 may move the bridge 110 in a number of different ways. For example, the solenoid 112 may move the bridge 110 using electromechanical force using an electrical current supplied by the sensing and control circuitry 114. In other embodiments, the solenoid 112 may simply remove mechanical barriers preventing the bridge 110 from moving in response to a mechanical bias (e.g., spring). This allows the bridge 100 to move in a desired direction.

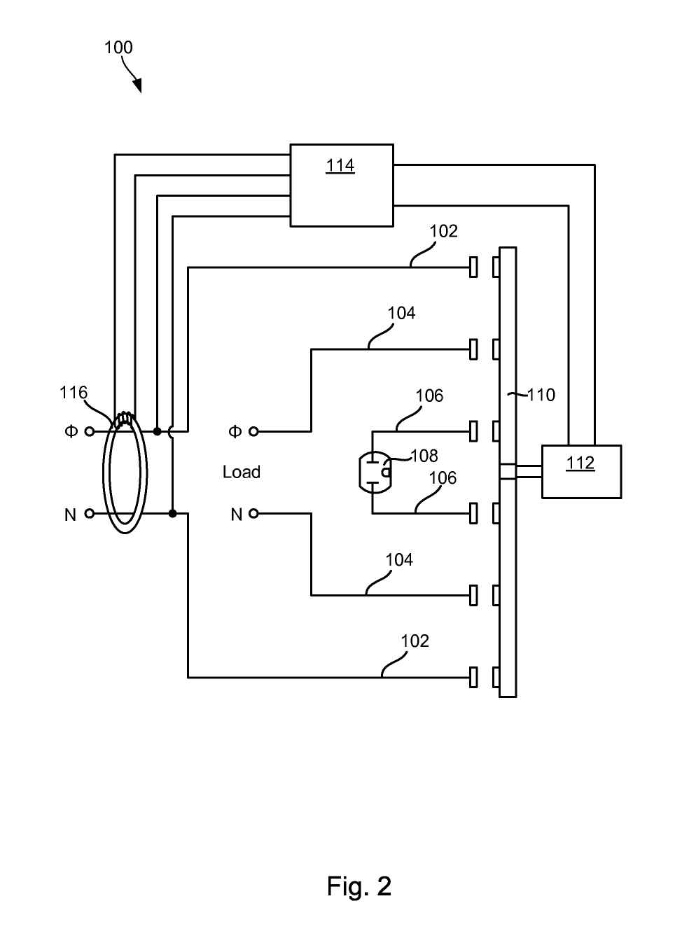

Referring now to FIG. 2, a high-level mechanical drawing of one embodiment of a GFCI 100 is illustrated. As shown, one embodiment of a GFCI 100 may include input lines 102, load output lines 104, receptacle output lines 106, a receptacle 108, a movable bridge 110, a solenoid 112, and sensing and control circuitry 114. In the embodiment, the movable bridge 110 isolates the contacts to the phase and neutral legs of the input lines 102, load output lines 104, and receptacle output lines 106. Furthermore, as shown, the input lines 102, load output lines 104, and receptacle output lines 106 are isolated from one another when the movable bridge 110 is disengaged or disconnected from the lines 102, 104, 106.

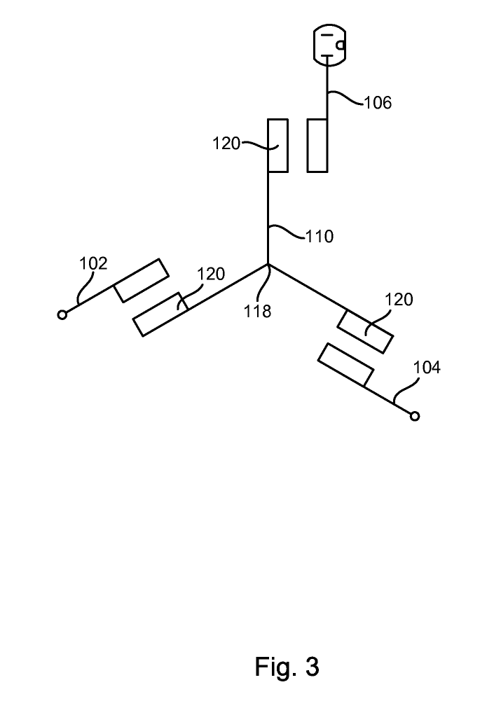

Referring to FIG. 3, one alternative embodiment of a movable bridge 110 is illustrated. Although the previous embodiments of the invention have shown a movable bridge 110 that moves in a substantially linearly direction, non-linear movement is also possible. For example, FIG. 3 illustrates one embodiment of a movable bridge 110 that rotates about an axis 118. For clarity, the movable bridge 110 only includes connectors 120 or contacts 120 corresponding to the neutral conductors of the input lines 102, load output lines 104, and receptacle output lines 106. However, it will be readily appreciated that other embodiments of a movable bridge 110 may connect the phase conductors of the input lines 102, load output lines 104 and receptacle output lines 106.

For example, a movable bridge 110 may include phase and neutral contacts 120 rotating together about a common axis. Alternatively, the phase and neutral contacts 120 may rotate independently or about different axes. Such an embodiment could use multiple solenoids 112 or other actuators 112 to rotate the phase and neutral contacts 120 independently, if desired.

While the examples used herein for the safety-enhanced circuit interrupter 100 are primarily directed to a GFCI 100, it should be understood that structures and operating principles thereof apply to embodiments of the invention serving as other circuit interrupting devices such as arc fault circuit interrupters, appliance leakage fault interrupters, equipment fault leakage interrupters, immersion detection interrupters, and the like. A detector of a predetermined condition corresponding to any such foregoing fault, connected to control and actuation elements, causes movement of the bridge 110 likewise as above.

The present invention may be embodied in other specific forms without departing from its operating principles or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A circuit interrupting device comprising:
(a) an input line to conduct electrical current from a source of electricity;
(b) a first output line to conduct electrical current to a load;
(c) a second output line to conduct electrical current to a receptacle;
(d) a movable bridge to electrically connect and disconnect the input line, first output line, and second output line, to and from one another;
(e) a circuit interrupting mechanism to disconnect the input line, first output line, and second output line from one another by moving the movable bridge into an open position upon detection of a predetermined condition; and
(f) a reset mechanism to electrically connect the input line, first output line, and second output line to one another by moving the movable bridge into a closed position.

2. The circuit interrupting device of claim 1, wherein the movable bridge rotates between the open and closed positions.

3. The circuit interrupting device of claim 1, wherein the movable bridge moves substantially linearly between the open and closed positions.

4. A circuit interrupting device comprising:
(a) an input line to conduct electrical current from a source of electricity;
(b) a plurality of output lines to conduct electrical current to at least one load;
(d) a movable bridge to electrically connect and disconnect the input line and each of the plurality of electrical output lines to and from one another;
(e) a circuit interrupting mechanism to disconnect the input line and each of the plurality of electrical output lines from one another by moving the movable bridge into an open position upon detection of a predetermined condition; and
(f) a reset mechanism to electrically connect the input line and each of the plurality of electrical output lines to one another by moving the movable bridge into a closed position.

5. A circuit interrupting device comprising:
(a) an input line to conduct electrical current from a source of electricity;
(b) a first output line to conduct electrical current to a load;
(c) a second output line to conduct electrical current to a receptacle;
(d) a bridge to electrically connect and disconnect the input line, the first output line, and the second output line to and from one another;
(e) a circuit interrupting mechanism to disconnect the input line, the first output line, and the second output line from one another by moving at least one of the input line, the first output line, the second output line, and the bridge into an open position upon detection of a predetermined condition; and
(f) a reset mechanism to electrically connect the input line, the first output line, and the second output line to one another by moving at least one of the input line, the first output line, the second output line, and the bridge into a closed position.
